(19) United States
(12) Patent Application Publication
(10) Pub. No.: US 2025/0219119 A1
(43) Pub. Date: Jul. 3, 2025

(54) ELECTROLYTE MEMBRANE FOR HIGH-TEMPERATURE POLYMER ELECTROLYTE MEMBRANE FUEL CELL INCLUDING POLYMER ELECTROLYTE HAVING NOVEL STRUCTURE

(71) Applicants: HYUNDAI MOTOR COMPANY, Seoul (KR); Kia Corporation, Seoul (KR); INDUSTRY-ACADEMIC COOPERATION FOUNDATION GYEONGSANG NATIONAL UNIVERSITY, Jinju-si (KR)

(72) Inventors: Won Jae Choi, Seoul (KR); Songi Oh, Suwon-si (KR); Ah Hyeon Park, Suwon-si (KR); Sung Hee Shin, Incheon (KR); Hyoun Myung Park, Incheon (KR); Da Hee Kwak, Suwon-si (KR); Ki Hyun Kim, Yongin-si (KR); Hyeon Gyeong Lee, Changwon-si (KR); Yu Gyeong Jeong, Changwon-si (KR); In Hyeok Hwang, Geoje-si (KR); Chan Hee Choi, Pyeongtaek-si (KR); Soon Sik Hwang, Geoje-si (KR); Yu Eun Kim, Jinju-si (KR)

(73) Assignees: HYUNDAI MOTOR COMPANY, Seoul (KR); Kia Corporation, Seoul (KR); INDUSTRY-ACADEMIC COOPERATION FOUNDATION GYEONGSANG NATIONAL UNIVERSITY, Jinju-si (KR)

(21) Appl. No.: 18/806,214

(22) Filed: Aug. 15, 2024

(30) Foreign Application Priority Data
Dec. 28, 2023 (KR) 10-2023-0193798

(51) Int. Cl. H01M 8/102; H01M 8/1039; H01M 8/1067

(52) U.S. Cl. CPC H01M 8/102; H01M 8/1039; H01M 8/1067; H01M 2300/0025

(57) ABSTRACT

An electrolyte membrane includes a polymer electrolyte having a novel structure and a high-temperature polymer electrolyte membrane fuel cell including the same.

### CROSS-REFERENCE TO RELATED APPLICATION

The present application claims priority to Korean Patent Application No. 10-2023-0193798, filed on Dec. 28, 2023, the entire contents of which is incorporated herein for all purposes by this reference.

### BACKGROUND OF THE PRESENT DISCLOSURE

### Field of the Present Disclosure

The present disclosure relates to an electrolyte membrane including a polymer electrolyte having a novel structure and a high-temperature polymer electrolyte membrane fuel cell including the same.

### Description of Related Art

Depending on the operating temperature, polymer electrolyte membrane fuel cells may be classified into low-temperature polymer electrolyte membrane fuel cells that operate at 60° C. to 80° C. and high-temperature polymer electrolyte membrane fuel cells that operate at 120° C. to 200° C.

Low-temperature polymer electrolyte membrane fuel cells have expensive electrolyte membranes and require a carbon monoxide emission reducer configured to prevent catalyst poisoning and a water controller configured to precisely maintain water content of the electrolyte membrane.

Because high-temperature polymer electrolyte membrane fuel cells operate at high temperatures, they operate in a dry environment without water. Therefore, high-temperature polymer electrolyte membrane fuel cells are capable of solving problems of water flooding in electrodes and complex humidification systems.

High-temperature polymer electrolyte membrane fuel cells mainly use a phosphoric acid-doped polybenzimidazole (PBI)-based polymer for the electrolyte membrane. Polybenzimidazole-based polymers have a high glass transition temperature and are excellent in thermal stability and physicochemical stability. However, polybenzimidazole-based polymers have a limitation in that they are difficult to process due to low solubility thereof and mechanical properties thereof greatly deteriorate when phosphoric acid content increases. Moreover, phosphate groups may be released at high temperatures, causing electrode poisoning problems and system corrosion problems.

The information disclosed in this Background of the Invention section is only for enhancement of understanding of the general background of the invention and may not be taken as an acknowledgement or any form of suggestion that this information forms the related art already known to a person skilled in the art.

### BRIEF SUMMARY

Various aspects of the present disclosure are directed to providing an electrolyte membrane for a high-temperature polymer electrolyte membrane fuel cell with excellent thermal and chemical stability.

Various aspects of the present disclosure are directed to providing an electrolyte membrane for a high-temperature polymer electrolyte membrane fuel cell that is easy to process due to high solubility thereof.

Various aspects of the present disclosure are directed to providing an electrolyte membrane for a high-temperature polymer electrolyte membrane fuel cell that facilitates mass production.

Various aspects of the present disclosure are directed to providing an electrolyte membrane for a high-temperature polymer electrolyte membrane fuel cell with decreased release of proton conductive groups.

The objects of the present disclosure are not limited to the foregoing. The objects of the present disclosure will be able to be clearly understood through the following description and to be realized by the means described in the claims and combinations thereof.

Various aspects of the present disclosure are directed to providing an electrolyte membrane for a high-temperature polymer electrolyte membrane fuel cell, including a polymer electrolyte having proton conductivity, in which the polymer electrolyte may include a main chain including at least one of fluorene or biphenyl and a side chain including a nitrogen-containing functional group and a proton conductive functional group connected to the nitrogen-containing functional group. Preferably, the main chain may include fluorene and biphenyl.

The main chain may not include any bonds other than carbon-carbon bonds.

The proton conductive functional group may include a dihydrogen phosphate anion (H₂PO₄⁻).

The nitrogen-containing functional group may include a quaternary ammonium cation.

The nitrogen-containing functional group and the proton conductive functional group may be connected by electrostatic attraction.

The polymer electrolyte may be represented by Chemical Formula 1 below.

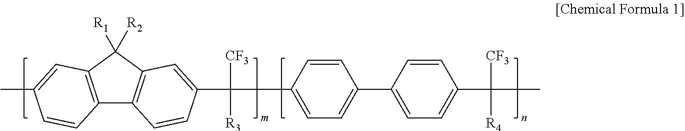

In Chemical Formula 1, R₁, R₂, R₃, and R₄ each include hydrogen, an alkyl group having 1 to 3 carbon atoms, or —(CH₂)ₓ—R₅·H₂PO₄⁻ (in which x is a number from 1 to 6), at least one selected from R₁, R₂, R₃, and R₄ includes —(CH₂)ₓ—R₅·H₂PO₄⁻ (in which x is a number from 1 to 6), R₅ includes —NR₆R₇R₈⁺, R₆, R₇, and R₈ each include an alkyl group having 1 to 3 carbon atoms; or two thereof are connected to each other to form a ring having 2 to 6 carbon atoms and the remaining one includes an alkyl group having 1 to 3 carbon atoms; and m and n satisfy 0<m<100 and m+n=100.

In Chemical Formula 1, at least two selected from R₁, R₂, R₃, and R₄ may include —(CH₂)ₓ—NH₃⁺·H₂PO₄⁻ (in which x is a number from 1 to 6).

The polymer electrolyte may be represented by Chemical Formula 2 below.

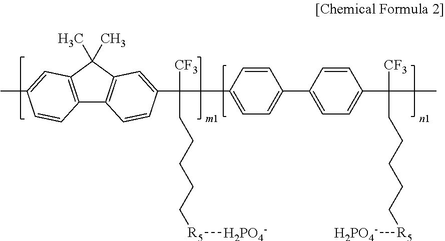

In Chemical Formula 2, R₅ includes —NR₆R₇R₈⁺, R₆, R₇, and R₈ each include an alkyl group having 1 to 3 carbon atoms; or two thereof are connected to each other to form a ring having 2 to 6 carbon atoms and the remaining one includes an alkyl group having 1 to 3 carbon atoms; and m1 and n1 satisfy 0<m1<100 and m1+n1=100.

The polymer electrolyte may be represented by Chemical Formula 3 below.

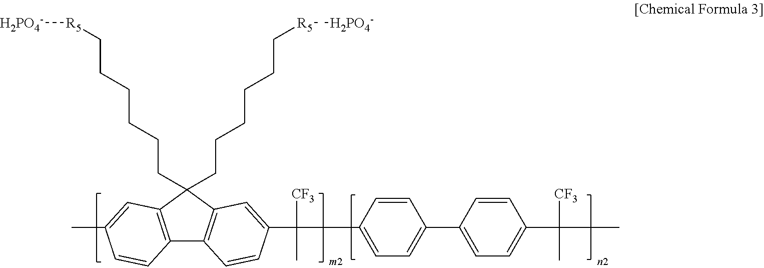

In Chemical Formula 3, R₅ includes —NR₆R₇R₈⁺, R₆, R₇, and R₈ each include an alkyl group having 1 to 3 carbon atoms; or two thereof are connected to each other to form a ring having 2 to 6 carbon atoms and the remaining one includes an alkyl group having 1 to 3 carbon atoms; and m2 and n2 satisfy 0<m2<100 and m2+n2=100.

The polymer electrolyte may have a residual amount of 90 wt % or more when the polymer electrolyte is subjected to a thermogravimetric analysis (TGA) at 200° C.

The electrolyte membrane may have proton conductivity of 200 mS/cm or more at 180° C.

Another aspect of the present disclosure provides a high-temperature polymer electrolyte membrane fuel cell, including the electrolyte membrane described above, an anode disposed on one surface of the electrolyte membrane, and a cathode disposed on another surface of the electrolyte membrane.

The high-temperature polymer electrolyte membrane fuel cell may operate at 120° C. to 200° C.

The high-temperature polymer electrolyte membrane fuel cell may operate at a relative humidity of 50% or less.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 shows a high-temperature polymer electrolyte membrane fuel cell according to an exemplary embodiment of the present disclosure;

FIG. 2 shows results of H¹ NMR for a starting material represented by Chemical Formula 4-1;

FIG. 3 shows results of H¹ NMR for an intermediate material represented by Chemical Formula 4-2;

FIG. 4 shows results of visual observation of an electrolyte membrane including a polymer electrolyte represented by Chemical Formula 4-3;

FIG. 5 shows results of H¹ NMR for a starting material represented by Chemical Formula 5-1;

FIG. 6 shows results of H¹ NMR for an intermediate material represented by Chemical Formula 5-2;

FIG. 7 shows results of visual observation of an electrolyte membrane including a polymer electrolyte represented by Chemical Formula 5-3;

FIG. 8 shows results of thermogravimetric analysis of polymer electrolytes according to Examples 1 and 2;

FIG. 9 shows a strain-stress curve of specimens according to Example 1;

FIG. 10 shows a strain-stress curve of specimens according to Example 2; and

FIG. 11 shows results of measurement of proton conductivity of electrolyte membranes according to Examples 1 and 2.

It may be understood that the appended drawings are not necessarily to scale, presenting a somewhat simplified representation of various features illustrative of the basic principles of the present disclosure. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments of the present disclosure, it will be understood that the present description is not intended to limit the invention(s) to those exemplary embodiments. On the contrary, the invention(s) is/are intended to cover not only the exemplary embodiments of the present disclosure, but also various alternatives, modifications, equivalents and other embodiments, which may be included within the spirit and scope of the invention as defined by the appended claims.

The above and other objects, features and advantages of the present disclosure will be more clearly understood from the following exemplary embodiments taken in conjunction with the accompanying drawings. However, the present disclosure is not limited to the embodiments disclosed herein, and may be modified into different forms. These embodiments are provided to thoroughly explain the present disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in the present specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in the present specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

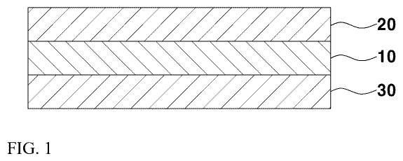

FIG. 1 shows a high-temperature polymer electrolyte membrane fuel cell according to an exemplary embodiment of the present disclosure.

The high-temperature polymer electrolyte membrane fuel cell may be a polymer electrolyte membrane fuel cell that operates at a high temperature of about 120° C. to 200° C. Alternatively, the high-temperature polymer electrolyte membrane fuel cell may be a polymer electrolyte membrane fuel cell that operates at a relative humidity of about 50% or less.

The high-temperature polymer electrolyte membrane fuel cell has the same structure or principle as existing low-temperature polymer electrolyte membrane fuel cells, but has advantages such as no water flooding in the anode and no need for a humidification system.

The high-temperature polymer electrolyte membrane fuel cell may include an electrolyte membrane 10, an anode 20 disposed on one surface of the electrolyte membrane 10, and a cathode 30 disposed on another surface of the electrolyte membrane 10.

The electrolyte membrane 10, the anode 20, and the cathode 30 are not limited in shape, thickness, area, etc., and any type commonly used in the technical field to which the present disclosure belongs may be applied.

The electrolyte membrane 10 may include a polymer electrolyte having proton conductivity. Here, proton conductivity may indicate the ability to conduct or exchange protons (H⁺) to move between the anode 20 and the cathode 30.

The polymer electrolyte may include a main chain and a side chain connected to the main chain. The main chain may include at least one of fluorene or biphenyl. Preferably, the main chain may include fluorene and biphenyl. The side chain may include a nitrogen-containing functional group and a proton conductive functional group connected to the nitrogen-containing functional group.

The nitrogen-containing functional group may include a quaternary ammonium cation. For example, the quaternary ammonium cation may be configured such that, when any one hydrogen in an ammonium cation (NH₄⁺) is a connection site, all remaining hydrogens are substituted with methyl groups (—CH₃).

The side chain may further include a linker connecting the nitrogen-containing functional group to the main chain. The linker is not particularly limited, and may include, for example, a substituted or unsubstituted alkyl group having 1 to 6 carbon atoms.

The proton conductive functional group may include a dihydrogen phosphate anion (H₂PO₄⁻).

The polymer electrolyte may include a compound represented by Chemical Formula 1 below.

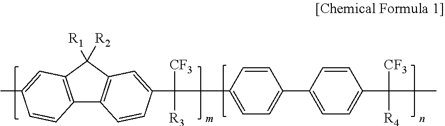

In Chemical Formula 1, R₁, R₂, R₃, and R₄ each include hydrogen, an alkyl group having 1 to 3 carbon atoms, or —(CH₂)ₓ—R₅·H₂PO₄⁻ (in which x is a number from 1 to 6), at least one of which may include —(CH₂)ₓ—R₅·H₂PO₄⁻ (in which x is a number from 1 to 6). Here, “·” may indicate electrostatic attraction between R₅ and dihydrogen phosphate anion (H₂PO₄⁻).

R₅ includes —NR₆R₇R₈⁺, in which R₆, R₇, and R₈ each include an alkyl group having 1 to 3 carbon atoms, or two thereof may be connected to each other to form a ring having 2 to 6 carbon atoms and the remaining one may include an alkyl group having 1 to 3 carbon atoms.

For example, R₅ may include

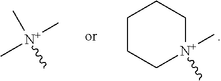

Here, [symbol] may indicate a connection site.

Also, in Chemical Formula 1, m and n may satisfy 0<m<100 and m+n=100.

In a preferred example of the polymer electrolyte, at least two selected from among R₁, R₂, R₃, and R₄ include —(CH₂)ₓ—R₅·H₂PO₄⁻ (in which x is a number from 1 to 6).

Any an embodiment of the polymer electrolyte may include a compound represented by Chemical Formula 2 below.

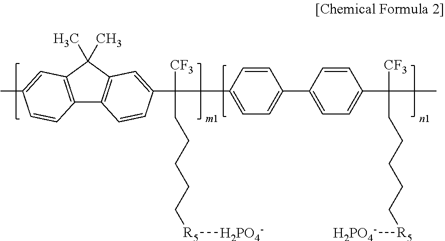

In Chemical Formula 2, R₅ includes —NR₆R₇R₈⁺, in which R₆, R₇, and R₈ each include an alkyl group having 1 to 3 carbon atoms, or two thereof may be connected to each other to form a ring having 2 to 6 carbon atoms and the remaining one may include an alkyl group having 1 to 3 carbon atoms, and m1 and n1 satisfy 0<m1<100 and m1+n1=100. In Chemical Formula 2, “ [symbol] ” may indicate electrostatic attraction between R₅ and dihydrogen phosphate anion (H₂PO₄⁻).

Another exemplary embodiment of the polymer electrolyte may include a compound represented by Chemical Formula 3 below.

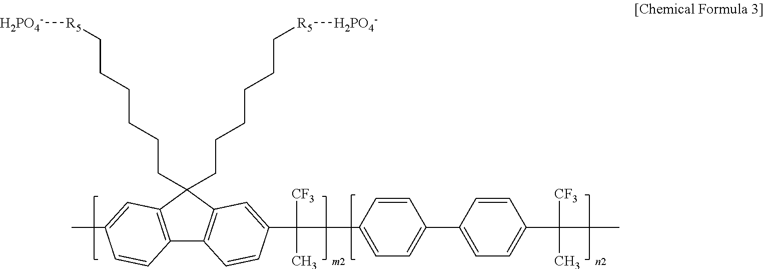

In Chemical Formula 3, R₅ includes —NR₆R₇R₈⁺, in which R₆, R₇, and R₈ each include an alkyl group having 1 to 3 carbon atoms, or two thereof may be connected to each other to form a ring having 2 to 6 carbon atoms and the remaining one may include an alkyl group having 1 to 3 carbon atoms, and m2 and n2 satisfy 0<m2<100 and m2+n2=100. In Chemical Formula 3, “ [symbol] ” may indicate electrostatic attraction between R₅ and dihydrogen phosphate anion (H₂PO₄⁻).

The polymer electrolyte is characterized in that the main chain does not include any bonds other than carbon-carbon bonds. Specifically, the main chain may be synthesized through condensation polymerization of a strong acid and may be composed of only carbon-carbon bonds. If the main chain includes an aryl ether bond (Csp2-O) or a benzylic C—H bond with low binding energy, it may be decomposed in a high temperature environment. Since the polymer electrolyte according to an exemplary embodiment of the present disclosure does not include the above bonds, it has excellent thermal and chemical stability.

In addition, the polymer electrolyte is a composite of a fluorene-based tilt main chain and a branched structure, and has a large free volume, which is the space between atoms, so it has high solubility in an aprotic solvent. Existing phosphoric acid-doped polybenzimidazole-based polymers have the problem of low solubility and difficult processing. The polymer electrolyte according to an exemplary embodiment of the present disclosure has high solubility and excellent processability.

In addition, the polymer electrolyte may be synthesized by condensation polymerization of monomers in the presence of an acid catalyst at room temperature for about 3 hours, which is advantageous for mass production.

In addition, the polymer electrolyte may include an ion-pair structure in which a proton conductive functional group is connected to a nitrogen-containing functional group. The interaction of the ion-pair structure may maintain higher attractive force than that of existing phosphoric acid-doped polybenzimidazole-based polymers, thus solving the problem of release of phosphoric acid at high temperatures.

Each of the anode 20 and the cathode 30 may include a catalyst and an ionomer.

The catalyst may include any material commonly used in the technical field to which the present disclosure belongs. For example, the catalyst may include a precious metal catalyst such as platinum (Pt), a non-precious metal catalyst, or an alloy catalyst thereof.

The ionomer may include any material commonly used in the technical field to which the present disclosure belongs. For example, the ionomer may include a phosphoric acid-doped polybenzimidazole-based polymer or the same polymer electrolyte as the electrolyte membrane 10 described above.

A better understanding of the present disclosure may be obtained through the following examples. These examples are merely set forth to illustrate the present disclosure, and are not construed as limiting the scope of the present disclosure.

### Example 1

A starting material represented by Chemical Formula 4-1 below was synthesized in the following manner. 9,9-Dimethylfluorene (1 g, 5.15 mmol), biphenyl (7.14 g, 46.33 mmol), and 7-bromo-1,1,1-trifluoroheptan-2-one (13.99 g, 56.62 mmol) were prepared as monomers. Trifluoromethanesulfonic acid (TFSA) (77.25 g, 514.75 mmol) was prepared as a catalyst. Dichloromethane (DCM) as a reaction solvent was prepared in an amount of 23 parts by weight based on 100 parts by weight of the monomers, and 100 parts by weight of the monomers and the catalyst were added to the reaction solvent to prepare a reactant. The reactant was maintained at about 5° C. for about 30 minutes, and then reacted at room temperature (about 20° C. to 25° C.) for about 3 hours and 30 minutes to synthesize the starting material. The reaction result was precipitated in 1,300 ml of methanol, washed several times with methanol, and dried in a vacuum oven at about 40° C., thereby obtaining the starting material.

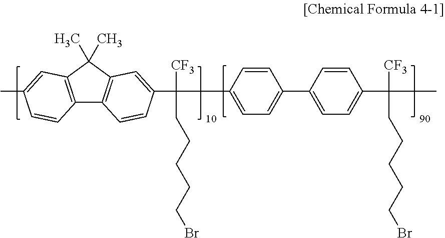

Using the above starting material, an intermediate material represented by Chemical Formula 4-2 was synthesized in the following manner.

100 parts by weight of the starting material (3 g, 7.75 mmol) was dissolved in 10 parts by weight of dimethylacetamide (DMAc), and then trimethylamine (2.14 ml, 27.11 mmol) was added to prepare a reactant. The reactant was reacted at room temperature (about 20° C. to 25° C.) for about 24 hours to synthesize the intermediate material. The reaction result was precipitated in 500 ml of tetrahydrofuran (THF), washed several times with acetone, and dried in a vacuum oven at about 60° C., thereby obtaining the intermediate material.

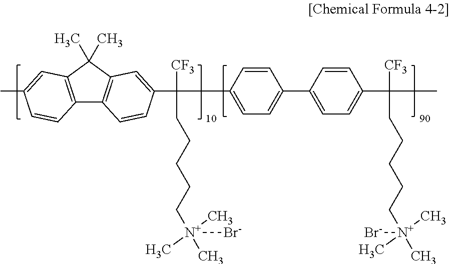

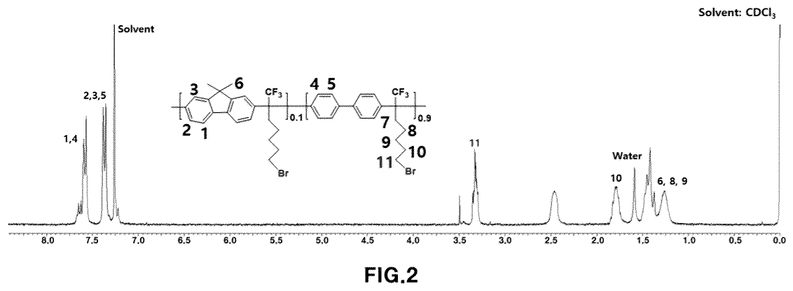

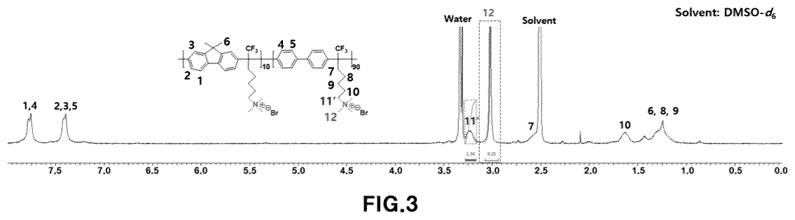

FIG. 2 shows results of H¹ NMR for the starting material represented by Chemical Formula 4-1. FIG. 3 shows results of H¹ NMR for the intermediate material represented by Chemical Formula 4-2.

Referring to FIG. 2, the phenyl peak of the polymer main chain was observed at 7.0 ppm to 8.0 ppm, and the alkyl group peak of the side chain was observed at 1.0 ppm to 3.5 ppm.

Referring to FIG. 3, the conversion rate was determined to be 100% through the integration ratio (2:9) of the CH₂ (11′) peak next to the modifiable position at the end of the side chain and the peak (12) caused by the newly introduced functional group.

Using the above intermediate material, an electrolyte membrane including a polymer electrolyte represented by Chemical Formula 4-3 below was manufactured in the following manner.

0.4 g of the intermediate material was dissolved in dimethylsulfoxide (DMSO), cast on an 8 cm×8 cm glass plate, and dried in a drying oven at about 60° C. for about 8 hours to prepare a membrane. The membrane was placed in a phosphoric acid solution having a concentration of about 85 wt % and rested in an oven at about 60° C. for about 75 hours. Phosphoric acid on the membrane surface was removed with a polytetrafluoroethylene film, thereby obtaining an electrolyte membrane with a thickness of about 40 μm.

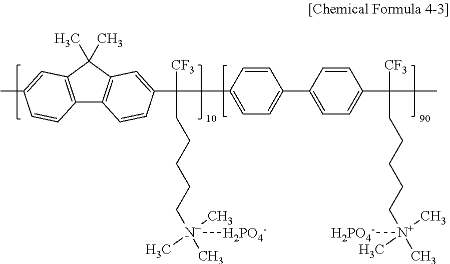

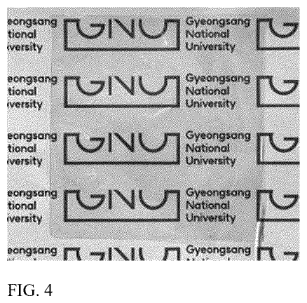

FIG. 4 shows results of visual observation of the electrolyte membrane including the polymer electrolyte represented by Chemical Formula 4-3.

### Example 2

9,9-Bis(6-bromohexyl)-9H-fluorene (3 g, 6.09 mmol), biphenyl (0.94 g, 6.09 mmol), and 1,1,1-trifluoroacetone (1.50 g, 13.41 mmol) were prepared as monomers. Trifluoromethanesulfonic acid (TFSA) (18.29 g, 13.41 mmol) was prepared as a catalyst. Dichloromethane (DCM) as a reaction solvent was prepared in an amount of 20 parts by weight based on 100 parts by weight of the monomers, and 100 parts by weight of the monomers and the catalyst were added to the reaction solvent to prepare a reactant. The reactant was maintained at about 5° C. for about 1 hour and 30 minutes, and then reacted at room temperature (about 20° C. to 25° C.) for about 30 minutes to synthesize the starting material. The reaction result was precipitated in 700 ml of methanol, washed several times with methanol, and dried in a vacuum oven at about 40° C., thereby obtaining the starting material.

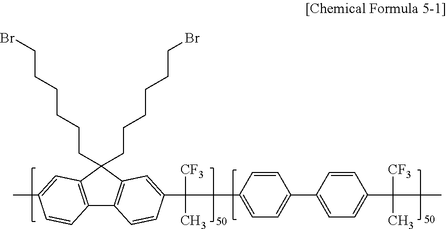

Using the above starting material, an intermediate material represented by Chemical Formula 5-2 below was synthesized in the following manner.

100 parts by weight of the starting material (3 g, 6.74 mmol) was dissolved in 10 parts by weight of dimethylacetamide (DMAc), and then (1.85 ml, 23.58 mmol) was added to prepare a reactant. The reactant was reacted at room temperature (about 20° C. to 25° C.) for about 24 hours to synthesize the intermediate material. The reaction result was precipitated in 500 ml of tetrahydrofuran (THF), washed several times with acetone, and dried in a vacuum oven at about 60° C., thereby obtaining the intermediate material.

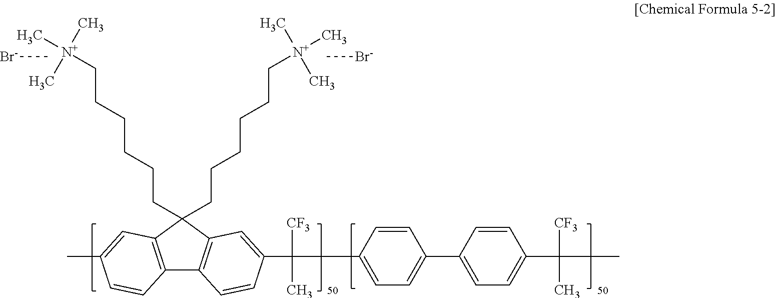

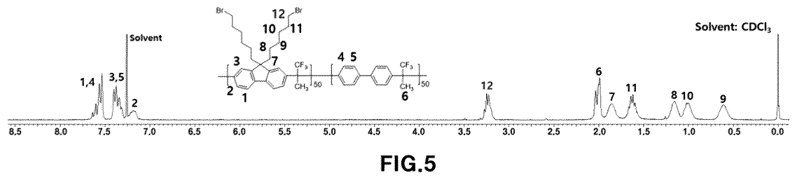

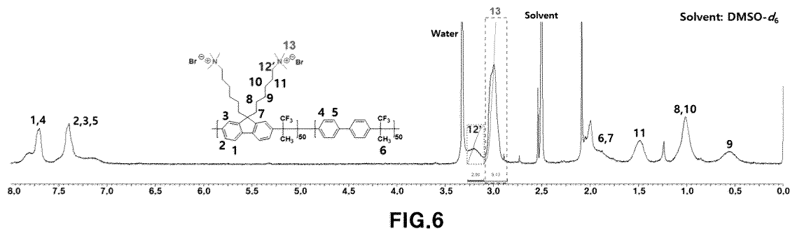

FIG. 5 shows results of H¹ NMR for the starting material represented by Chemical Formula 5-1. FIG. 6 shows results of H¹ NMR for the intermediate material represented by Chemical Formula 5-2.

Referring to FIG. 5, the phenyl peak of the polymer main chain was observed at 7.0 ppm to 8.0 ppm, and the alkyl group peak of the side chain was observed at 1.0 ppm to 3.5 ppm.

Referring to FIG. 6, the conversion rate was determined to be 100% through the integration ratio (2:9) of the CH₂ (12′) peak next to the modifiable position at the end of the side chain and the peak (13) caused by the newly introduced functional group.

Using the above intermediate material, an electrolyte membrane including a polymer electrolyte represented by Chemical Formula 5-3 below was manufactured in the following manner.

0.4 g of the intermediate material was dissolved in dimethylsulfoxide (DMSO), cast on an 8 cm×8 cm glass plate, and dried in a drying oven at about 60° C. for about 8 hours to prepare a membrane. The membrane was placed in a phosphoric acid solution having a concentration of about 85 wt % and rested in an oven at about 60° C. for about 75 hours. Phosphoric acid on the membrane surface was removed with a polytetrafluoroethylene film, thereby obtaining an electrolyte membrane with a thickness of about 40 μm.

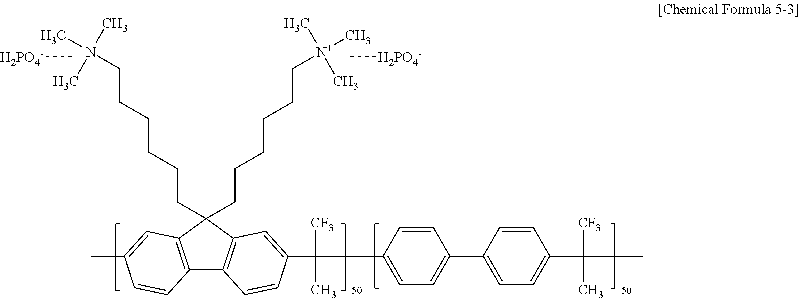

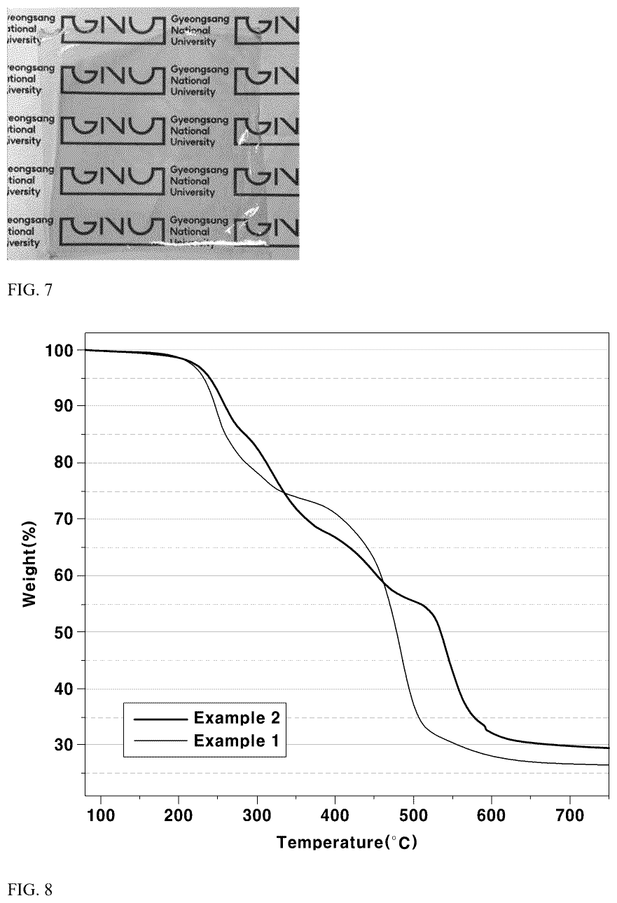

FIG. 7 shows results of visual observation of the electrolyte membrane including the polymer electrolyte represented by Chemical Formula 5-3.

Thermogravimetric analysis (TGA) was performed on the polymer electrolytes according to Examples 1 and 2. Specifically, thermogravimetric analysis was performed on the intermediate materials obtained in Examples 1 and 2. Since the only difference between the intermediate material and the polymer electrolyte is the presence or absence of a proton conductive functional group, the results for the intermediate material are substantially the same as the results for the polymer electrolyte.

Each sample was heated from room temperature to about 120° C. at a rate of about 20° C./min and maintained for about 10 minutes to remove residual water. Thereafter, the sample was cooled to about 60° C. at a rate of about 20° C./min, and then heated to about 800° C. at a rate of about 10° C./min under a nitrogen atmosphere, and the change in weight of the sample was measured. The results thereof are as shown in FIG. 8.

FIG. 8 shows results of thermogravimetric analysis of the polymer electrolytes according to Examples 1 and 2. Referring thereto, in Example 1, the remaining amount was about 95% at about 208.5° C., and the remaining amount was about 90% at about 246.4° C. In Example 2, the remaining amount was about 95% at 239.3° C., and the remaining amount was about 90% at about 258.9° C. Based on results of thermogravimetric analysis in Examples 1 and 2, the remaining amount was 90 wt % or more at 200° C., showing excellent thermal stability. Here, “remaining amount” may indicate the ratio of the initial mass of the sample to the mass at the corresponding temperature.

The starting material and the intermediate material according to Example 1 were manufactured into membrane-type specimens, after which the mechanical properties of each specimen were measured. After attaching a 250 N load cell to a LLOYD UTM LS1 device, each specimen cut according to ASTM D 638 type V was fastened thereto. Extension rate was set at 5 mm/min. Three samples were measured for each specimen, and the average and standard deviation values of the strain-stress curve, Young's modulus, and elongation were determined.

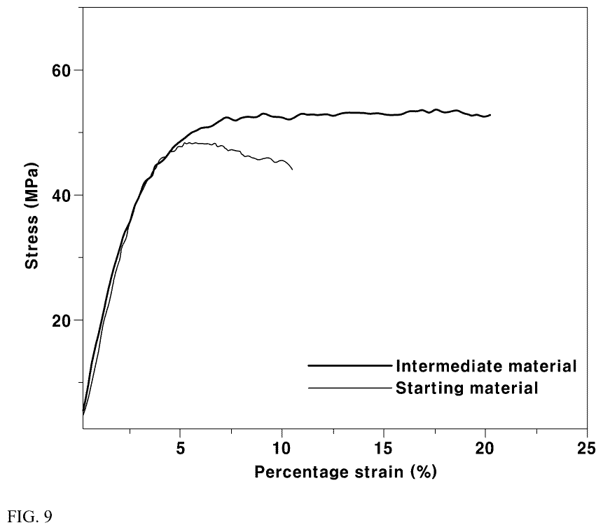

FIG. 9 shows a strain-stress curve of the specimens according to Example 1. The mechanical properties of each specimen are shown in Table 1 below.

TABLE 1

| | Tensile | Young's | Elongation |
|---|---|---|---|
| | strength | modulus | at break |
| Classification | [MPa] | [Pa] | [%] |
| Starting material | 46.85 ± 2.23 | 2239.22 ± 666.63 | 12.01 ± 7.48 |
| (Chemical Formula 4-1) | | | |
| Intermediate material | 55.57 ± 1.10 | 2094.92 ± 198.87 | 19.41 ± 3.11 |
| (Chemical Formula 4-2) | | | |

The starting material and the intermediate material according to Example 2 were manufactured into membrane-type specimens, after which the mechanical properties of each specimen were measured. After attaching a 250 N load cell to a LLOYD UTM LS1 device, each specimen cut according to ASTM D 638 type V was fastened thereto. Extension rate was set at 5 mm/min. Three samples were measured for each specimen, and the average and standard deviation values of the strain-stress curve, Young's modulus, and elongation were determined.

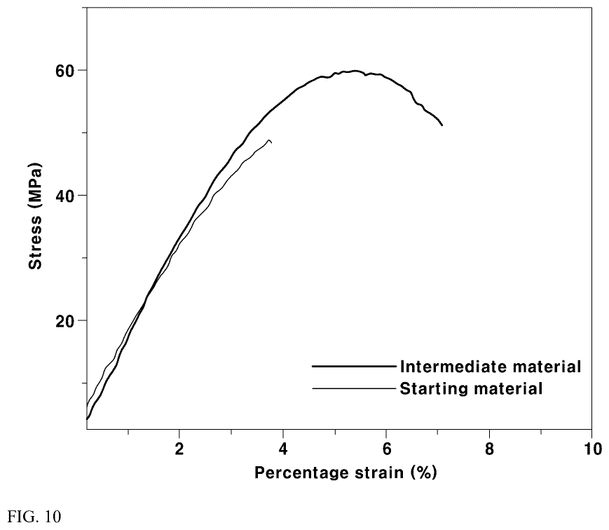

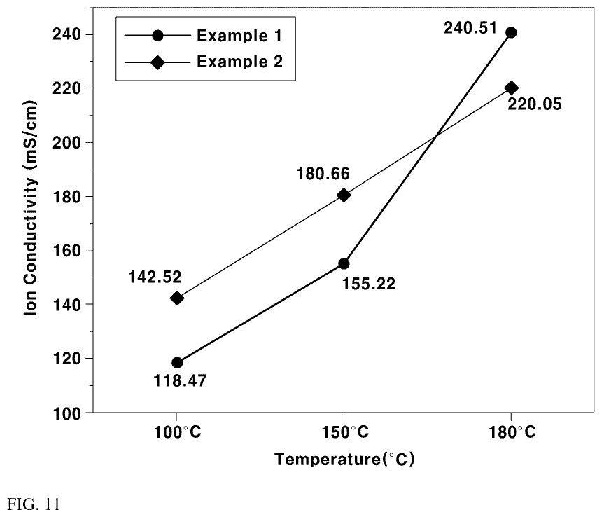

FIG. 10 shows a strain-stress curve of the specimens according to Example 2. The mechanical properties of each specimen are shown in Table 2 below.

TABLE 2

| | Tensile | Young's | Elongation |
|---|---|---|---|
| | strength | modulus | at break |
| Classification | [MPa] | [Pa] | [%] |
| Starting material | 48.63 ± 1.83 | 1936.07 ± 197.46 | 4.06 ± 0.23 |
| (Chemical Formula 5-1) | | | |
| Intermediate material | 60.19 ± 1.97 | 2237.73 ± 185.19 | 6.74 ± 1.00 |
| (Chemical Formula 5-2) | | | |

Based on the above results, the intermediate material modified with quaternary ammonium cation exhibited high tensile strength and elongation.

The proton conductivity of the electrolyte membranes according to Examples 1 and 2 was measured. Each electrolyte membrane was made into a 0.5 cm×3 cm specimen and fastened to a 4-probe cell, after which resistance thereof was measured using electrochemical spectroscopy (SP-240, Bio Logic Science Instrument, France). Under conditions of 100% relative humidity with the cell placed in secondary distilled water, resistance values depending on temperature changes from about 30° C. to 90° C. were measured and proton conductivity was calculated using the following equation.

$$Proton conductivity ( σ ) [ mS / cm ] = d / R \cdot S$$

Here, d is the distance between electrodes, R is the resistance value, and S is the value obtained by multiplying the thickness of the specimen by the width.

The resistance value was measured when distilled water containing the cell reached each temperature up to 180° C., and the resistance value was measured and recorded six times at each temperature.

FIG. 11 shows results of measurement of proton conductivity of the electrolyte membranes according to Examples 1 and 2. Referring thereto, Examples 1 and 2 exhibited proton conductivity of 200 mS/cm or more at 180° C.

A high-temperature polymer electrolyte membrane fuel cell was manufactured by attaching electrodes including a platinum catalyst to both surfaces of the electrolyte membrane according to Example 1. The high-temperature polymer electrolyte membrane fuel cell operated at 160° C. and 180° C. and performance thereof was measured. The results thereof are shown in Table 3 below.

TABLE 3

| | | | | Peak | |
|---|---|---|---|---|---|
| | | | Cell | power | |
| Operating | Pt loading | OCV | Voltage [V] | density | HFR |
| temperature | [mg/cm²] | [V] | @ 0.2A/cm² | [W/cm²] | [mΩ · cm²] |
| 160° C. | Anode | 0.594 | 0.553 | 0.527 | 80.84 |
| | 0.922 | | | | |
| 180° C. | Cathode | 0.587 | 0.552 | 0.529 | 83.85 |
| | 0.998 | | | | |

A high-temperature polymer electrolyte membrane fuel cell was manufactured by attaching electrodes including a platinum catalyst to both surfaces of the electrolyte membrane according to Example 2. The high-temperature polymer electrolyte membrane fuel cell operated at 160° C. and 180° C. and performance thereof was measured. The results thereof are shown in Table 4 below.

TABLE 4

| | | | | Peak | |
|---|---|---|---|---|---|
| | | | Cell | power | |
| Operating | Pt loading | OCV | Voltage [V] | density | HFR |
| temperature | [mg/cm²] | [V] | @ 0.2A/cm² | [W/cm²] | [mΩ · cm²] |
| 160° C. | Anode | 1.000 | 0.698 | 0.701 | 118.6 |
| | 0.922 | | | | |
| 180° C. | Cathode | 1.007 | 0.707 | 0.747 | 115.9 |
| | 0.998 | | | | |

According to the present disclosure, it is possible to obtain an electrolyte membrane for a high-temperature polymer electrolyte membrane fuel cell with excellent thermal and chemical stability.

According to the present disclosure, it is possible to obtain an electrolyte membrane for a high-temperature polymer electrolyte membrane fuel cell that is easy to process due to high solubility thereof.

According to the present disclosure, it is possible to obtain an electrolyte membrane for a high-temperature polymer electrolyte membrane fuel cell that facilitates mass production.

According to the present disclosure, it is possible to obtain an electrolyte membrane for a high-temperature polymer electrolyte membrane fuel cell with decreased release of proton conductive groups.

The effects of the present disclosure are not limited to the above-mentioned effects. It should be understood that the effects of the present disclosure include all effects that can be inferred from the description of the present disclosure.

The foregoing descriptions of test examples and specific exemplary embodiments of the present invention have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present invention, as well as various alternatives and modifications thereof. It is intended that the scope of the present disclosure be defined by the Claims appended hereto and their equivalents.

What is claimed is:

1. An electrolyte membrane for a high-temperature polymer electrolyte membrane fuel cell, the electrolyte membrane comprising:
a polymer electrolyte having proton conductivity,
wherein the polymer electrolyte comprises a main chain comprising at least one of fluorene or biphenyl and a side chain comprising a nitrogen-containing functional group and a proton conductive functional group connected to the nitrogen-containing functional group.

2. The electrolyte membrane of claim 1, wherein the main chain does not comprise any bonds other than carbon-carbon bonds.

3. The electrolyte membrane of claim 1, wherein the proton conductive functional group comprises a dihydrogen phosphate anion (H₂PO₄⁻).

4. The electrolyte membrane of claim 1, wherein the nitrogen-containing functional group comprises a quaternary ammonium cation.

5. The electrolyte membrane of claim 1, wherein the nitrogen-containing functional group and the proton conductive functional group are connected by electrostatic attraction.

6. The electrolyte membrane of claim 1, wherein the polymer electrolyte is represented by Chemical Formula 1 below: 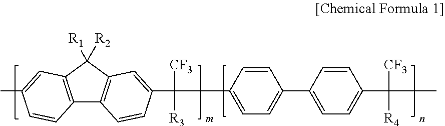
in Chemical Formula 1, R₁, R₂, R₃, and R₄ each comprise hydrogen, an alkyl group having 1 to 3 carbon atoms, or —(CH₂)ₓ—R₅·H₂PO₄⁻, wherein x is a number from 1 to 6,
at least one selected from R₁, R₂, R₃, and R₄ comprises —(CH₂)ₓ—R₅·H₂PO₄⁻, wherein x is a number from 1 to 6,
R₅ comprises —NR₆R₇R₈⁺,
R₆, R₇, and R₈ each comprise an alkyl group having 1 to 3 carbon atoms; or two of the R₆, R₇, and R₈ are connected to each other to form a ring having 2 to 6 carbon atoms and a remaining one of the R₆, R₇, and R₈ comprises an alkyl group having 1 to 3 carbon atoms; and
$$m and n satisfy 0 < m < 100 and m + n = 100.$$

7. The electrolyte membrane of claim 6, wherein, in Chemical Formula 1, at least two selected from R₁, R₂, R₃, and R₄ comprise —(CH₂)ₓ—R₅·H₂PO₄⁻, wherein x is a number from 1 to 6.

8. The electrolyte membrane of claim 1, wherein the polymer electrolyte is represented by Chemical Formula 2 below: 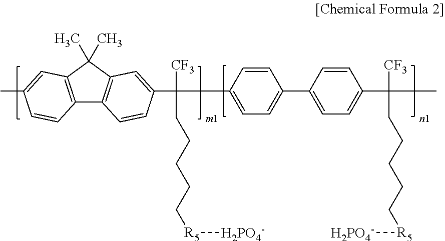
in Chemical Formula 2, R₅ comprises —NR₆R₇R₈⁺,
R₆, R₇, and R₈ each comprise an alkyl group having 1 to 3 carbon atoms; or two of the R₆, R₇, and R₈ are connected to each other to form a ring having 2 to 6 carbon atoms and a remaining one of the R₆, R₇, and R₈ comprises an alkyl group having 1 to 3 carbon atoms; and
$$m 1 and n 1 satisfy 0 < m 1 < 100 and m 1 + n 1 = 100.$$

9. The electrolyte membrane of claim 1, wherein the polymer electrolyte is represented by Chemical Formula 3 below: 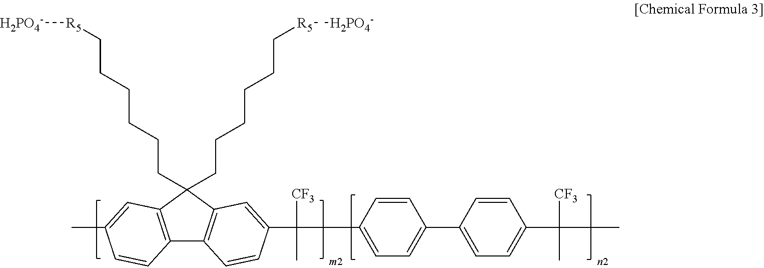
in Chemical Formula 3, R₅ comprises —NR₆R₇R₈⁺,
R₆, R₇, and R₈ each comprise an alkyl group having 1 to 3 carbon atoms; or two of the R₆, R₇, and R₈ are connected to each other to form a ring having 2 to 6 carbon atoms and a remaining one of the R₆, R₇, and R₈ comprises an alkyl group having 1 to 3 carbon atoms; and
$$m 2 and n 2 satisfy 0 < m 2 < 100 and m 2 + n 2 = 100.$$

10. The electrolyte membrane of claim 1, wherein the polymer electrolyte has a residual amount of 90 wt % or more when the polymer electrolyte is subjected to a thermogravimetric analysis (TGA) at 200° C.

11. The electrolyte membrane of claim 1, wherein the electrolyte membrane has proton conductivity of 200 mS/cm or more at 180° C.

12. A high-temperature polymer electrolyte membrane fuel cell, comprising:
the electrolyte membrane claim 1;
an anode disposed on one surface of the electrolyte membrane; and
a cathode disposed on another surface of the electrolyte membrane.

13. The high-temperature polymer electrolyte membrane fuel cell of claim 12, wherein the high-temperature polymer electrolyte membrane fuel cell operates at 120° C. to 200° C.

14. The high-temperature polymer electrolyte membrane fuel cell of claim 12, wherein the high-temperature polymer electrolyte membrane fuel cell operates at a relative humidity of 50% or less.
